(19) United States
(12) Patent Application Publication
(10) Pub. No.: US 2013/0197984 A1
(43) Pub. Date: Aug. 1, 2013

(54) Socially Shared Ads

(71) Applicants: Rushi P. Bhatt, Bangalore (IN); Sachin Garg, Bangalore (IN); Shrutivandana Sharma, Bangalore (IN)

(72) Inventors: Rushi P. Bhatt, Bangalore (IN); Sachin Garg, Bangalore (IN); Shrutivandana Sharma, Bangalore (IN)

(73) Assignee: YAHOO! INC., Sunnyvale, CA (US)

(21) Appl. No.: 13/360,931

(22) Filed: Jan. 30, 2012

(51) Int. Cl. G06Q 30/02

(52) U.S. Cl. 705/14.16

(57) ABSTRACT

Promoting on-line advertisements in a social network context includes steps of: selecting a parameter on whose value to base a discount to an on-line user; selecting a discount level to use; incentivizing advertisement sharing behavior of the on-line user by offering the discount level to the user along with the on-line advertisement association with the discount; computing a value of the discount; and providing the discount value to the on-line user.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of Internet services, and more particularly relates to the field of on-line advertising on socially shared media.

### BACKGROUND OF THE INVENTION

Social advertising is gaining mind-share among advertisers and is becoming an important advertising medium at websites such as Yahoo!®. Additionally, popular social utility websites such as Facebook now feature “social advertisements” where users “like” and/or “follow” advertisements. Well-“liked” ads get placed with a higher rate.

A social ad is an ad format which can be run either as a graphical banner, a text banner or a search advertisement. The graphical social ads may optionally include interactions (like visiting advertiser site, taking a survey, watching an embedded video, and so on). The distinguishing feature of a social ad is that its creatives are augmented with a facility to share the ad creative with one's social connections (e.g., by posting the banner link to Facebook, sending the creative by email to friends, and IM'ing a friend about the creative). The downstream friends of the user sharing the creative can further propagate the ad amongst their own social connections. See FIGS. 1-3 for an example of a graphical social ad. It is known that a message or an advertisement coming from within a user's own social network carries more weight and has a bigger impact than the same message that is sent directly from the marketer. The next logical questions then are:

1. How best to price socially sharable advertisement to account for the incremental return on investment (“ROI”) to the advertiser? and

2. How to optimally provide incentives to users so that they readily re-share the ads to their friends or social network profiles?

Currently, no Yahoo!® advertising channel, including guaranteed delivery (GD), non-guaranteed delivery (NGD), and Sponsored Search, takes into account the incremental reach or the benefits of social ad sharing while pricing or placing the advertisement. To summarize, currently, we have no models that automatically assign discount amounts or optimal pricing to ads that take into account further social propagation of advertisement.

### SUMMARY OF THE INVENTION

Briefly, according to an embodiment of the invention, a method of promoting on-line advertisements includes steps or acts of: selecting a parameter on whose value to base a discount to an on-line user; selecting a discount level to use;

incentivizing advertisement sharing behavior of the on-line user by offering the discount level to the user along with the on-line advertisement association with the discount; computing a value of the discount; and providing the discount value to the on-line user.

According to another embodiment of the present invention, a system for promoting on-line advertisements includes: a memory including computer-executable instructions and a processor device operably coupled with the memory for performing the method steps above.

According to another embodiment of the present invention, a computer program product includes a non-transitory computer readable medium that includes computer executable instructions for performing the method steps for promoting on-line advertisements.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is an example of a social ad, according to the known art;

FIG. 2 is an example of a social ad, according to the known art;

FIG. 3 is an example of a social ad, according to the known art;

FIG. 4 is a flowchart of a method for incentivizing a user to share an advertisement, according to an embodiment of the present invention;

FIG. 5 is a flowchart of the method of FIG. 4, wherein the publisher offers the discount, according to an embodiment of the present invention;

FIG. 6 is a flowchart of the method wherein a publisher uses discounts to maximize its instantaneous expected revenue, according to an embodiment of the present invention;

FIG. 7 is a flowchart of the method wherein advertisers directly offer discounts to the users, according to an another embodiment of the present invention;

FIG. 8 is a flowchart of the method wherein an auction-based system incorporates discount offers in ad selection, according to another embodiment of the present invention;

FIG. 9 shows an NGD scenario of ad impressions, according to an embodiment of the present invention;

FIG. 10 shows a GD scenario, according to an embodiment of the present invention;

FIG. 11 is a high level block diagram showing an information processing system configured to operate according to an embodiment of the present invention; and

FIG. 12 is a flowchart of an algorithmic method of incentivizing the sharing of ads, according to an embodiment of the present invention.

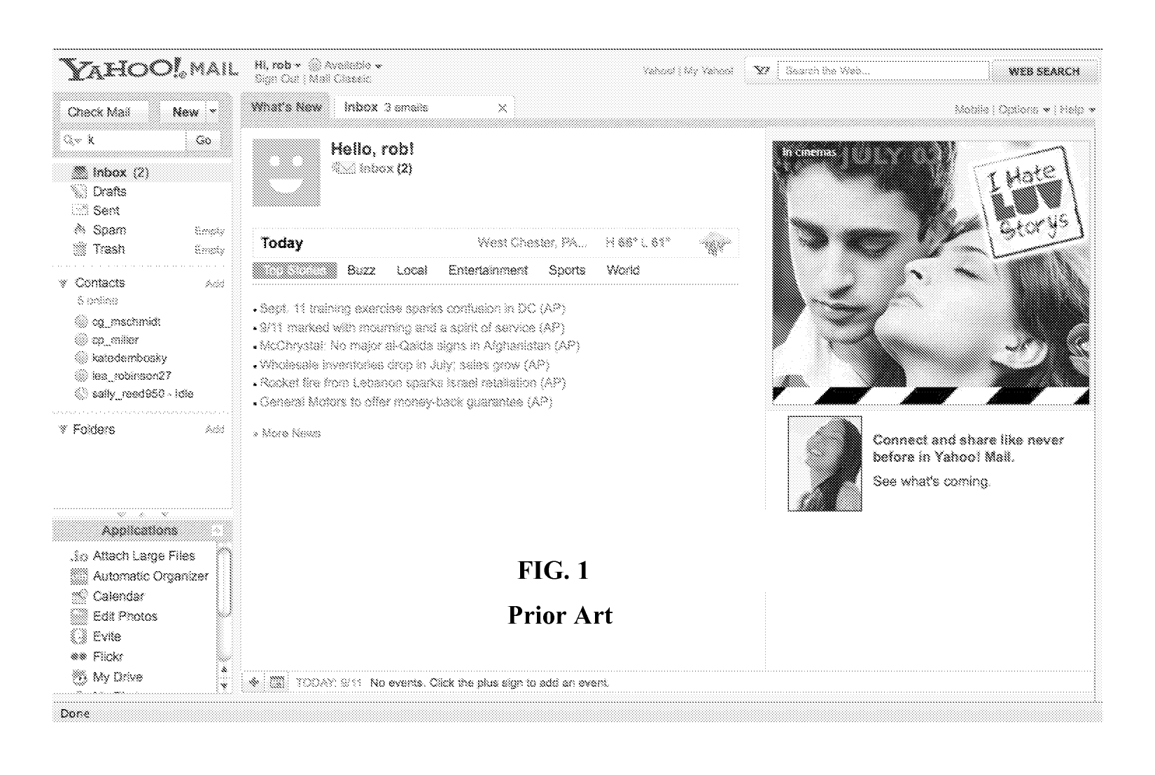

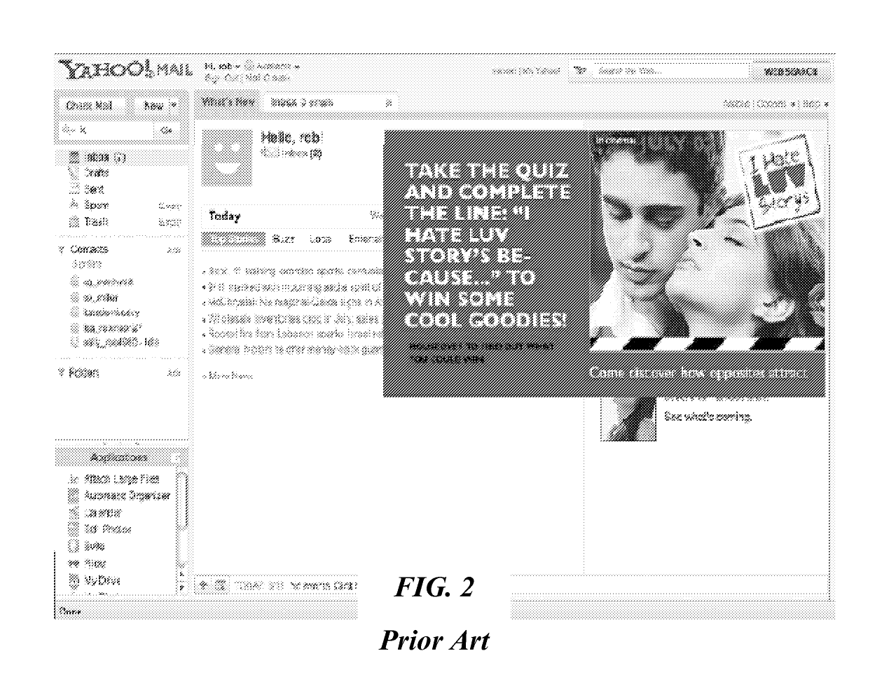

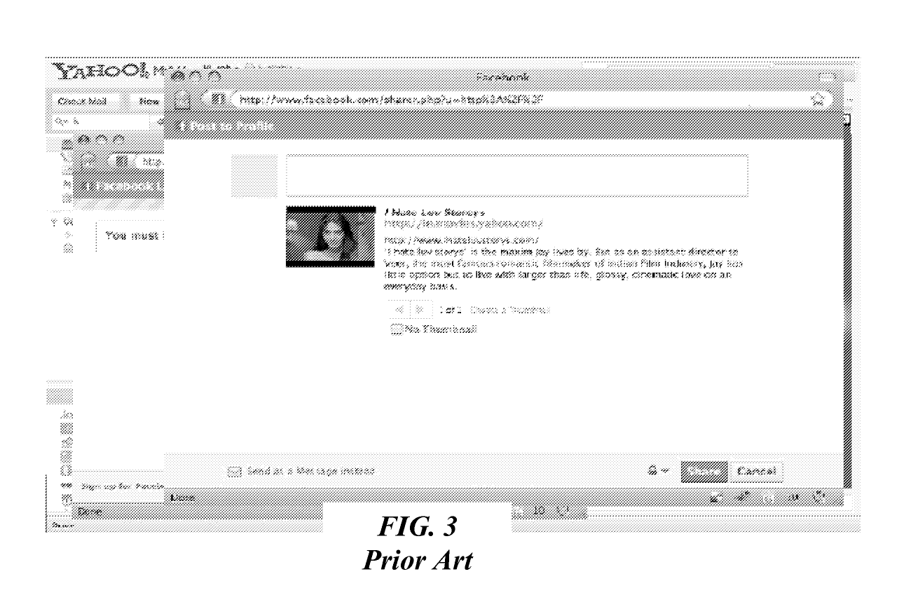

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible computing embodiment may not be depicted in order to facilitate a less obstructed view of these various embodiments.

We describe new methods for the monetization, pricing, and targeting of social advertisements (“ads”). To this end we provide adaptive, automatic, and algorithmic ways of pricing on-line ads and offering discounts to users based on the users' social ad sharing propensities. This in turn promotes the social propagation of advertisements, which in turn leads to increased revenue and increased “mind-share.” This sharing-sensitive price estimator can benefit the Right Media Exchange (RMX) and NGD exchanges, Sponsored Search eCPM estimation, as well as GD analytics platforms like the Yahoo! Advertising Analytics product. Right Media Exchange (RMX) from Yahoo! is currently the world's No. 1 display advertising exchange platform.

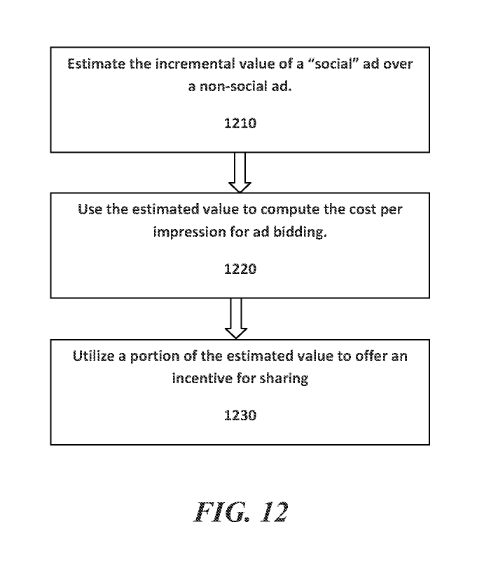

Referring now to the drawings and to FIG. 12 in particular, we discuss our algorithmic method for incentivizing ad sharing, according to an embodiment of the present invention. The method begins by estimating the incremental earnings value provided by a social ad over a “vanilla” non-sharable advertisement, be it a banner advertisement or a text advertisement, in step 1210. The incremental value estimate can be based on the expected number of ad shares by the user, the expected downstream click-through rate (CTR), or the expected downstream conversions, and other factors. These expected values can be derived through learning and prediction models using the knowledge of the user's social network, the observed online activities of the user and his/her friends, and the past observed sharing/click/conversion data for the respective ad. The CTR for an ad is usually represented as a percentage amount representing the number of clicks on an ad divided by the number of times the ad is shown (“impressions”).

Next, in step 1220 we use this incremental value in computing the correct effective cost per thousand impressions (eCPM) value for the ad while bidding for placement in the NGD exchange, or for estimating the CPM value during GD proposal creation. The eCPM is calculated as: (Total Earnings/Impressions)*1000, where Total Earnings is equal to the Revenue attributed to the ad+Incremental Revenue of social sharing of the ad. Note that we use the eCPM formula by way of example because it is well known in the industry. Other formulas for computing an effective cost value for the ad using the incremental value are contemplated within the spirit and scope of the invention. Whatever algorithm is selected must have as an input the incremental value derived from step 1210.

In step 1230 part of the incremental revenue expected from social sharing can be utilized as an incentive for users to share the ad. For example, if we know that a Yahoo! user is particularly conducive to share ads of a certain category with his/her friends on Facebook, Twitter, or Yahoo! Mail or Pulse, we can increase the chances that he/she will indeed do so by boosting the discount level offered in the ad. For example, for the best of our users we may offer a 50% discount on a product instead of a 40% discount, or offer the particularly lucrative offers only to users who are predicted to be repeat buyers or very “sticky” users. Sharing estimates can also be used to offer group buy discounts. For example, if a tightly knit group of users is known to be interested in movie tickets, we may offer them a “buy-five-get-one-free” type deal for movie tickets subject to at least five of the friends purchasing the tickets.

This invention has the following advantages:

1) It increases the click and conversion yield by incentivizing sharing behavior of the users, as compared to the case where ads are sharable, but without incentives;

2) It increases reach (same reason as above);

3) It increases revenue by effectively trading off an increase in clicks/conversions with the discount / incentive offered by the publisher;

4) It increases return on investment (RoI) for the advertiser (since shared click / conversion rates are higher); and

5) It allows advertisers to compete not only on the bid, but also on the amount of discounts they can offer to the users. This benefits the end-users.

In all of the following discussion, the “discount” offered to the user implies any of the following: (a) an additional discount on the product/service advertised; (b) a gift voucher; or (c) credits given to the user that can be accumulated and redeemed on future specified products/services. The discount “level” or the “value” of the discount implies the monetary worth of the offered discount for the user. The success of social ads depends on the users' willingness to share ads. Our proposal below provides ways to incentivize the users to share ads with their network.

Incentivizing the user to share.

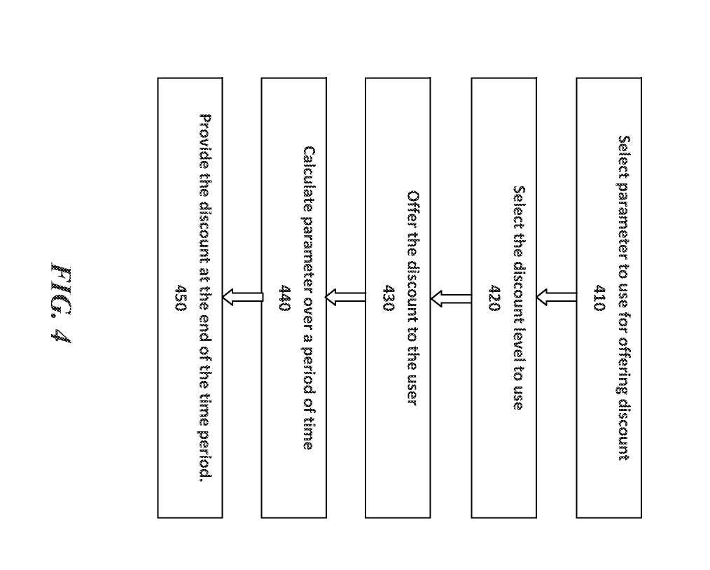

Referring now to FIG. 4, in one embodiment of the present invention, the user is offered a discount whose value is dependent on a parameter such as the number of downstream views/clicks/conversions generated by the ad the user shares. In step 410, the choice of the specific parameter (downstream views, clicks, conversions, or combination of these) would depend on the type of ad and the network over which the user is allowed to share the ads. The dependency of the discount level on the above numbers encourages the user to share more, and use better targeting while sharing ads.

Next in step 420 we select the discount level to use. This discount level can be percentage or other inducement. We offer the discount to the user in step 430.

For example, an offer may read as follows: “Share the ad with friends and accumulate 5% additional discount each time one of your friends clicks on the shared ad. Get your accumulated discount by email at the end of the week.” In the above incentive scheme, the user can either be told the per share discount upfront, e.g. the 5% value in the above example, or this value can be left unspecified to the user. In the latter case, the user directly gets the total discount at the end of the pre-specified period.

To compute the discount, in step 440 the above number is calculated over a pre-specified time period which is the same for all users. At the end of this period the discount is delivered to the user in step 450. The discounts discussed above can be offered to the user either by the publisher or by the advertiser. In the next two points we discuss each of these cases separately.

Publisher offers the discount to the user.

Referring now to FIG. 5, discounts can be used by a publisher to increase the spread of ads by incentivizing the users to share. This is especially useful in scenarios where the publisher has a contract with an advertiser to deliver some specified number of ad impressions/clicks/conversions in a given time period, and the advertiser's payment to the publisher is contingent upon the fulfillment of this contract. An example is a GD ad campaign. During such a contract period the publisher can dynamically adjust the discount level, based on the ad delivery achieved so far, to induce an increase/decrease in ad sharing in future so as to fulfill the contract in the remaining time. The dynamic discount adjustment can be done using stochastic optimization techniques.

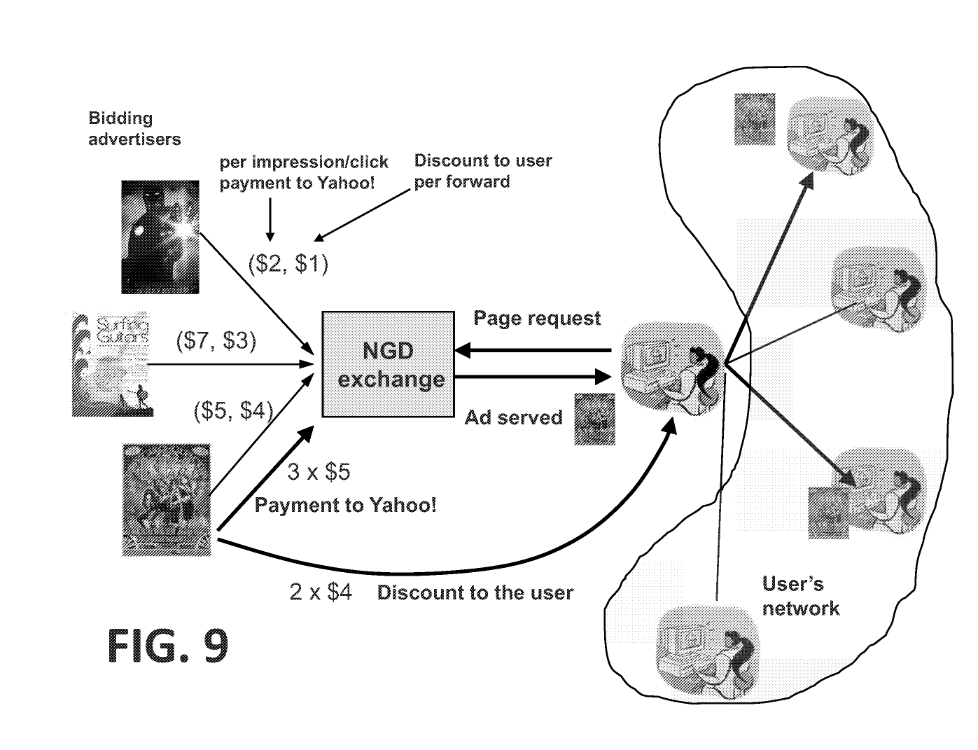

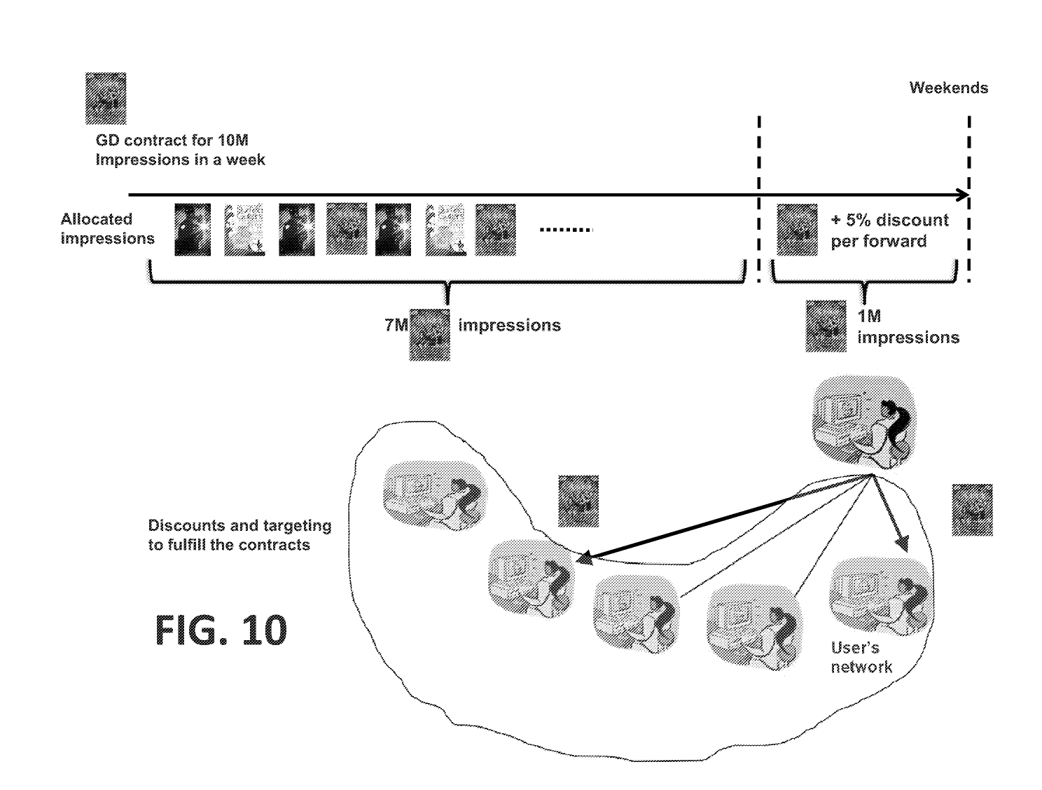

Also, by using “targeting” based on the knowledge of the users' social network and their online social activities, the publisher can target “appropriate” discounts for different users in the future. An example of the above scenario is shown in FIGS. 9 and 10 where the advertiser offers a 5% discount towards the end of the week to achieve its target 10M impressions.

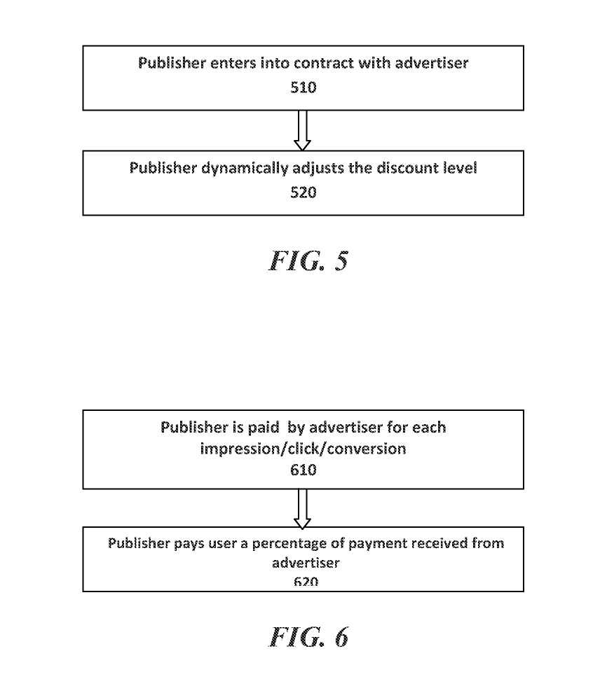

Apart from the abovementioned contract based scenarios, a publisher can also use discounts to maximize its instantaneous expected revenue. We refer now to FIG. 6. For example in an NGD setting, in step 610 advertisers pay for each impression/click/conversion, the publisher can offer appropriate discounts to the users to achieve a large spread of the ad in the users' network. By optimizing over the discount value, the publisher can optimally trade off the cost of payment to the user with the profit it obtains from the advertisers' payments for multiplied impressions/clicks/conversions. FIG. 10 shows a GD example of a system operating according to an embodiment of the present invention.

Advertiser offers the discount to the user.

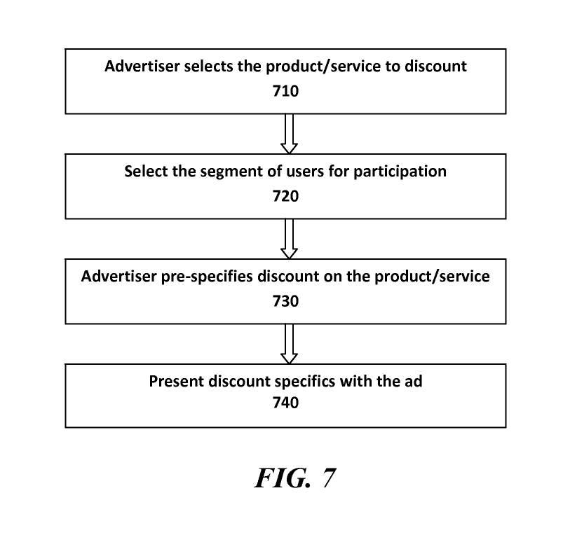

In another embodiment of the present invention, advertisers can directly offer discounts to the users to attract more customers. Referring now to FIG. 7, an advertiser can pre-specify the discount it wants to offer on a given product/service to a given segment of users. First the advertiser selects the products and/or services to discount in step 710. Then the advertiser selects the user segment for participation in step 720. The segment of the user population selected can be based on location, profile characteristics (age, sex) and other parameters, such as network engagement, behavioral targeting, social centrality, activity levels of a user's friends, diversity in geographic and behavioral attributes in the user's friends' circles, or any combination of these features.

In step 730 the advertiser specifies the discount it will offer. The value of this discount can be contingent on the number of downstream customers. When this advertiser's ad is shown to the users in step 740, they are also shown the specifics of the discount offer set by the advertiser. In an alternate setting, an advertiser can pre-specify the maximum discount value instead of an exact value described above. The advertiser can then let the publisher decide the exact value of the discount (within the range specified by the advertiser) on the fly based on the real-time data from the users. The publisher can use the techniques mentioned above to dynamically adjust the discount value so as to optimize its own revenue or the advertiser's benefit.

In systems where advertisers pre-specify the discounts, there should be a mechanism to incorporate this information on the discounts and their expected influence on ad propagation to select the best “social” ad. The auction mechanism proposed below provides such a mechanism for NGD systems.

Auction based system to incorporate advertiser's discount offers in ad selection.

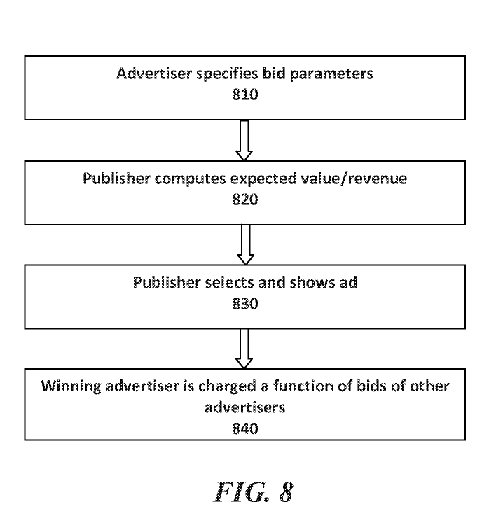

Referring now to FIG. 8, when there are multiple advertisers competing for an ad slot, and some of them are offering discounts to the users, the following auction-based mechanism can be used for ad selection and pricing. In step 810, each advertiser specifies as its bid (i) the maximum payment it is willing to make to the publisher for each ad impression/click/conversion, and (ii) the maximum discount it is willing to offer to a user for each downstream impression/click/conversion.

In step 820, the publisher uses the discount value specified by the advertiser, and its knowledge of the function that relates discount values to ad forwarding probabilities, to compute the expected value/revenue this ad can bring from the incoming user's network. It can then select and show the ad that maximizes the expected value/revenue in step 830. The winning advertiser is charged for each view/click/conversion by the user as well as by its downstream connections in step 840. The price charged to the advertiser by the publisher for each of these events would be a function of the bids of other advertisers.

This price function can be designed to achieve various objectives such as truthful bidding by the advertisers, advertisers' value maximization, publisher's revenue maximization etc. The discount value offered to the user can either be the maximum discount value (bid) specified by the advertiser, or it can be some lesser value that may depend on the bids of other advertisers too. An example of the auction based system described above is shown in FIG. 9.

In the case of bulk discounts similar to those in Groupon™, a popular website featuring discount gift certificates in a “deal of the day,” we are proposing a dynamic discounting strategy as opposed to a fixed discount in Groupon™. In our case, the amount of discount increases with the volume of shares/re-shares. In Groupon™, the discount remains fixed with a pre-decided number of users ‘buying-into’ the ad/offer.

Also, for NGD specifically, our mechanism is auction-based, where both discounts and bids are taken into account to determine the winning ad.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Hardware Embodiment.

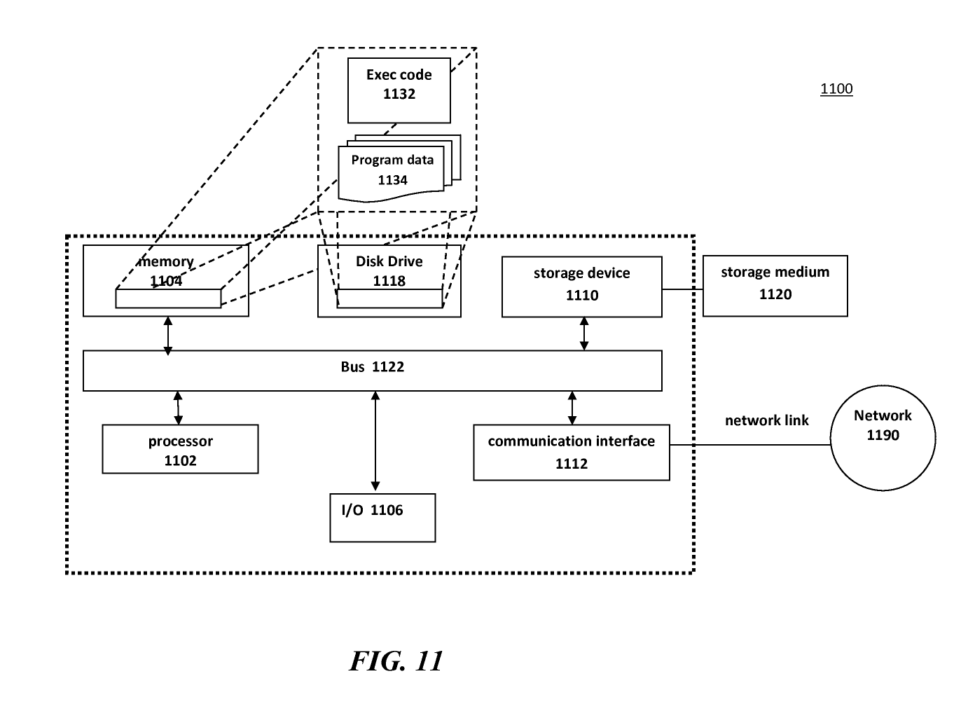

Referring now in specific detail to the drawings, and particularly FIG. 11, there is provide a simplified pictorial illustration of an information processing system in which the present invention may be implemented. For purposes of this invention, computer system 1100 may represent any type of computer, information processing system or other programmable electronic device, including a client computer, a server computer, a portable computer, an embedded controller, a personal digital assistant, and so on. The computer system 1100 may be a stand-alone device or networked into a larger system. Computer system 1100, illustrated for exemplary purposes as a networked computing device, is in communication with other networked computing devices (not shown) via network 1110. As will be appreciated by those of ordinary skill in the art, network 1110 may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 1100 via one or more data networks such as, for example, network 110. However, for ease of understanding, aspects of the invention have been embodied in a single computing device--computer system 1100.

Computer system 1100 includes processing device 1102 which communicates with various input devices, output devices and network 1110. The processor 1102 is connected to a communication infrastructure 1122 (e.g., a communications bus, cross-over bar, or network). The processor device 102 may be a general or special purpose microprocessor operating under control of computer program instructions executed from memory 1104. The processor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. The memory may be partitioned or otherwise mapped to reflect the boundaries of the various memory subcomponents.

Memory 1104 includes both volatile and persistent memory for the storage of: operational instructions for execution by CPU 1102, data registers, application storage and the like. Memory 1104 preferably includes a combination of random access memory (RAM), read only memory (ROM) and persistent memory such as that provided by a hard disk drive. The computer instructions/applications stored in memory 1104 and executed by processor 1102.

The I/O subsystem 1106 may comprise various end user interfaces such as a display, a keyboards, and a mouse. The I/O subsystem 1106 may further comprise a connection to a network such as a local-area network (LAN) or wide-area network (WAN) such as the Internet. The computer system may include a display interface 1108 that forwards graphics, text, and other data from the communication infrastructure 1102 (or from a frame buffer not shown) for display on the display unit 1110. The computer system also includes a main memory 1104, preferably random access memory (RAM), and may also include a secondary memory 1112. The secondary memory 1112 may include, for example, a hard disk drive 1114 and/or a removable storage drive 1111, representing a floppy disk drive, a magnetic tape drive, an optical disk drive, etc. The removable storage drive 1111 reads from and/or writes to a removable storage unit 1118 in a manner well known to those having ordinary skill in the art. Removable storage unit 1118, represents a floppy disk, a compact disc, magnetic tape, optical disk, etc. which is read by and written to by removable storage drive 1111. As will be appreciated, the removable storage unit 1118 includes a computer readable medium having stored therein computer software and/or data.

The computer system may also include a communications interface 1124. Communications interface 1124 allows software and data to be transferred between the computer system and external devices. Examples of communications interface 1124 may include a modem, a network interface (such as an Ethernet card), a communications port, a PCMCIA slot and card, etc. Software and data transferred via communications interface 1124 are in the form of signals which may be, for example, electronic, electromagnetic, optical, or other signals capable of being received by communications interface 1124. These signals are provided to communications interface 1124 via a communications path (i.e., channel). This channel carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory and secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for promoting on-line advertisements, comprising:
using a processor device to perform:
selecting a parameter on whose value to base a discount to an on-line user;
selecting a discount level to use;
incentivizing advertisement sharing behavior of the on-line user by offering the discount level to the user along with the on-line advertisement associated with said discount;
computing a value of the discount; and
providing the discount value to the on-line user.

2. The method of claim 1 wherein selecting the parameter is based on a type of on-line advertisement.

3. The method of claim 1 wherein selecting the parameter comprises selecting at least one parameter of a group of parameters consisting of: downstream views, a click, a conversion, and a combination of the parameters.

4. The method of claim 1 wherein selecting the discount level comprises selecting a percentage of price.

5. The method of claim 1 wherein computing the value of the discount comprises calculating an amount per parameter over a pre-specified time period.

6. The method of claim 6 further comprising dynamically adjusting the discount level based on downstream advertisement sharing achieved up to a certain point.

7. The method of claim 1 wherein selecting the discount level to use is based on knowledge of the on-line user's social network and the on-line user's on-line social behavior.

8. The method of claim 7 further comprising estimating an incremental value provided by a social advertisement over a non-social advertisement.

9. An information processing system for promoting on-line advertisements comprising:
a memory comprising computer executable instructions; and
a processor device operably coupled to the memory and causing a computer to perform steps of:
selecting a parameter on whose value to base a discount to an on-line user;
selecting a discount level to use;
incentivizing advertisement sharing behavior of the on-line user by offering the discount level to the user along with the on-line advertisement associated with said discount;
computing a value of the discount; and
providing the discount value to the on-line user.

10. The information processing system of claim 9 wherein selecting the parameter is based on a type of on-line advertisement.

11. The information processing system of claim 9 wherein selecting the parameter comprises selecting at least one parameter of a group of parameters consisting of: downstream views, a click, a conversion, and a combination of the parameters.

12. The information processing system of claim 9 wherein computing the value of the discount comprises calculating an amount per parameter over a pre-specified time period.

13. The information processing system of claim 12 further comprising dynamically adjusting the discount level based on downstream advertisement sharing achieved up to a certain point.

14. The information processing system of claim 9 wherein selecting the discount level to use is based on knowledge of the on-line user's social network and the on-line user's online social behavior.

15. The information processing system of claim 9 further comprising estimating an incremental value provided by a social advertisement over a non-social advertisement.

16. A computer program product comprising a non-transitory computer readable storage medium comprising instructions that cause a computer to perform:
selecting a parameter on whose value to base a discount to an on-line user;
selecting a discount level to use;
incentivizing advertisement sharing behavior of the on-line user by offering the discount level to the user along with the on-line advertisement associated with said discount;
computing a value of the discount; and
providing the discount value to the on-line user.

17. The computer program product of claim 16 wherein selecting the parameter comprises selecting at least one parameter of a group of parameters consisting of: downstream views, a click, a conversion, and a combination of the parameters.

18. The computer program product of claim 16 further comprising dynamically adjusting the discount level based on downstream advertisement sharing achieved up to a certain point.

19. The computer program product of claim 16 wherein selecting the discount level to use is based on knowledge of the on-line user's social network and the on-line user's online social behavior.

20. The computer program product of claim 16 further comprising estimating an incremental value provided by a social advertisement over a non-social advertisement.
